(19) United States
(12) Patent Application Publication
(10) Pub. No.: US 2019/0300761 A1
(43) Pub. Date: Oct. 3, 2019

(54) MULTI-FUNCTIONAL AQUEOUS LIQUID ADHESIVE AND METHOD FOR PREPARING THE SAME

(71) Applicant: ZHEJIANG KAIDA STATIONERY CO., LTD., Hangzhou (CN)

(72) Inventor: Li Yeping, Hangzhou (CN)

(21) Appl. No.: 16/207,975

(22) Filed: Dec. 3, 2018

(30) Foreign Application Priority Data
Apr. 2, 2018 (CN) 201810282526.1

(51) Int. Cl. C09J 129/04; C09J 131/04; C09J 133/08; C09J 139/06; C09J 9/00

(52) U.S. Cl. CPC C09J 129/04; C09J 131/04; C08L 33/02; C09J 139/06; C09J 9/00; C09J 133/08

(57) ABSTRACT

A multi-functional aqueous liquid glue and method for making the same, wherein the liquid glue includes the following components in parts by weight: 70 to 85 parts of deionized water, 15 to 20 parts of adhesive, 2 to 5 parts of humectant, 4 to 8 parts of glitter powder, 4 to 8 parts of luminous powder, 0.6 to 1.2 parts of suspending agent, 0.2 to 0.3 parts of bactericide, 0.4 to 0.8 parts of pigment, 0.1 to 0.2 parts of antifoaming agent, 0.4 to 0.5 parts of dispersant, and 0.1 parts of plasticizer. This liquid glue is soluble in water, can be cleaned by water, and can be used in coloring and drawing on papers, glass, ceramics and other materials which are not obviously rough.

### CROSS-REFERENCE TO RELATED APPLICATIONS

Under 37 CFR § 1.55, this non-provisional patent application claims the benefit of Chinese Application Serial No. 201810282526.1, which was filed with the Chinese Patent Office on Apr. 2, 2018.

### BACKGROUND OF THE INVENTION

The described invention relates in general to liquid glue preparations and methods for making the same, and more specifically to a multi-functional aqueous liquid glue having improved viscidity and luminous and glittering effects and methods for making the same.

At present, there are various types of liquid glue on the market for different needs. For example, firstly, there is ordinary liquid glue dedicated for paper pasting; secondly, there is adhesive, such as white glue, dedicated for bonding in wooden products; thirdly, there is multicolor glitter glue applied in coloring of paintings; and finally, there is also a corresponding base material used in the slime raw material for the luminous effect. However, multi-functional glue flexibly applicable to the foregoing different cases has not emerged, and the need for such a product or products remains.

### SUMMARY OF THE INVENTION

The following provides a summary of certain exemplary embodiments of the present invention. This summary is not an extensive overview and is not intended to identify key or critical aspects or elements of the present invention or to delineate its scope. However, it is to be understood that the use of indefinite articles in the language used to describe and claim the present invention is not intended in any way to limit the described system. Rather the use of “a” or “an” should be interpreted to mean “at least one” or “one or more”.

In accordance with one aspect of the present invention, a first multi-functional aqueous liquid glue is provided. This glue formulation includes deionized water, wherein the deionized water is present in 70 to 85 parts by weight; adhesive, wherein the adhesive is present in 15 to 20 parts by weight; humectant, wherein the humectant is present in 2 to 5 parts by weight; glitter powder, wherein the glitter powder is present in 4 to 8 parts by weight; luminous powder, wherein the luminous powder is present in 4 to 8 parts by weight; suspending agent, wherein the suspending agent is present in 0.6 to 1.2 parts by weight; bactericide, wherein the bactericide is present in 0.2 to 0.3 parts by weight; pigment, wherein the pigment is present in 0.4 to 0.8 parts by weight; antifoaming agent, wherein the antifoaming agent is present in 0.1 to 0.2 parts by weight; dispersant, wherein the dispersant is present in 0.4 to 0.5 parts by weight; and plasticizer, wherein the plasticizer is present in 0.1 parts by weight.

In accordance with another aspect of the present invention, a second multi-functional aqueous liquid glue is provided. This glue formulation includes deionized water, wherein the deionized water is present in 70 to 85 parts by weight; adhesive, wherein the adhesive is present in 15 to 20 parts by weight; and wherein the adhesive is polyvinyl alcohol, polyvinyl acetate emulsion, polyvinylpyrrolidone, acrylic emulsion, or combinations thereof; humectant, wherein the humectant is present in 2 to 5 parts by weight; and wherein the humectant is polyethylene glycol, propylene glycol, glycerol, sorbitol, or combinations thereof; glitter powder, wherein the glitter powder is present in 4 to 8 parts by weight; luminous powder, wherein the luminous powder is present in 4 to 8 parts by weight; and wherein the luminous powder is a short-acting powder that has been subjected to a waterproof coating treatment or a long-acting powder that has been subjected to a waterproof coating treatment; suspending agent, wherein the suspending agent is present in 0.6 to 1.2 parts by weight; and wherein the suspending agent is xanthan gum, carbomer resin, sodium carboxymethyl cellulose, or combinations thereof; bactericide, wherein the bactericide is present in 0.2 to 0.3 parts by weight; pigment, wherein the pigment is present in 0.4 to 0.8 parts by weight; antifoaming agent, wherein the antifoaming agent is present in 0.1 to 0.2 parts by weight; dispersant, wherein the dispersant is present in 0.4 to 0.5 parts by weight; and plasticizer, wherein the plasticizer is present in 0.1 parts by weight; and wherein the plasticizer is benzoic acid 990 of medium to high solubility or benzoic acid 988 of medium to high solubility.

In yet another aspect of this invention, a method for making a multi-functional aqueous liquid glue is provided. This method includes placing deionized water into a reaction tank; adding a suspending agent into the reaction tank in which the temperature is kept at 10° C. to 30° C.; performing continuous cutting and dispersion at a speed of 600 r/min to 1000 r/min to obtain a gel-like system with a high-suspension capacity; adding adhesive to the gel-like system with a high-suspension capacity at a temperature of 10° C. to 30° C.; stirring the mixture until the adhesive is evenly dispersed; raising the temperature to 80° C. to 90° C. with a stirring speed of 70 r/min to 80 r/min to produce a homogeneous and stable colloidal suspension, wherein the adhesive is transformed from a linear polymer structure to a three-dimensional net structure under the effect of the previously added suspending agent and such that colloidal suspension includes a large surface area, high adsorption capacity, and strong suspension capacity; lowering the temperature and maintaining the temperature at 30° C. to 50° C. after the colloidal suspension has been produced; adding luminous powder, glitter powder, humectant, bactericide, antifoaming agent, dispersant, and plasticizer in predetermined proportions to the colloidal suspension; stirring at a speed of 50 r/min to 60 r/min to obtain a homogeneous liquid suspension; adding a water-soluble pigment according to predetermined color specifications; stirring the suspension liquid thoroughly; lowering the temperature to 20° C. to 30° C.; and performing packaging of the glue or glue product.

Additional features and aspects of the present invention will become apparent to those of ordinary skill in the art upon reading and understanding the following detailed description of the exemplary embodiments. As will be appreciated by the skilled artisan, further embodiments of the invention are possible without departing from the scope and spirit of the invention. Accordingly, the following descriptions are to be regarded as illustrative and not restrictive in nature.

### DETAILED DESCRIPTION OF THE INVENTION

Exemplary embodiments of the present invention are described below. Although the following detailed description contains many specifics for the purposes of illustration, a person of ordinary skill in the art will appreciate that many variations and alterations to the following details are within the scope of the invention. Accordingly, the following embodiments of the invention are set forth without any loss of generality to, and without imposing limitations upon, the claimed invention.

As previously stated, the present invention relates in general to liquid glue preparations/formulations and methods for making the same, and more specifically to a multi-functional aqueous liquid glue having improved viscidity and luminous and glittering effects, and methods for making the same. The multi-functional aqueous liquid glue of the present invention is soluble in water, can be cleaned by or with water, and can be used in coloring and drawing on papers, glass, ceramics and other materials, which may or may not have rough textures. By using a borax solution and boric acid solution, the present invention can be transformed from a liquid form to gelatinous multi-color slime having a luminous effect. Luminous powder with a waterproof coating is optionally used in such a slime process. In a preferred ratio scheme, the slime, when excited by light, still exhibits luminosity after three hours. In preparing the glue formulas of the present invention, a suspending agent is firstly added to deionized water having a temperature of 10° C. to 30° C. with continuous high-speed cutting and dispersion to obtain a gel-like system having a high-suspension capacity and the temperature is subsequently raised rapidly to 80° C. to 90° C. The adhesive is then added with continuous dispersion to finally obtain a colloidal dispersed system having a three-dimensional net structure. This system provides a large surface area, high adsorption capacity, and strong suspension capacity. Thus, after adsorption of subsequently added luminous powder (which is high-content metal oxide, and which is more than three times the weight of the system itself) and glitter powder (which is slightly higher than the weight of the system), the system can still maintain a suspension condition. In addition, a water-soluble pigment can be added to the system as required to prepare multi-functional liquid glue.

Compared to prior art systems, the multi-functional liquid glue of the present invention provides an aqueous feature, is super sticky, and includes luminous and glittering effects. The liquid glue of the present invention has various characteristics which can be used in various applications; thus, it is not necessary to buy liquid glue separately for such applications. Various embodiments of this invention are described in detail below.

In accordance with a first exemplary embodiment of the present invention, a multi-functional aqueous liquid glue includes the following components according to their parts by weight: 70 to 85 parts of deionized water; 15 to 20 parts of adhesive; 2 to 5 parts of humectant; 4 to 8 parts of glitter powder; 4 to 8 parts of luminous powder; 0.6 to 1.2 parts of suspending agent; 0.2 to 0.3 parts of bactericide; 0.4 to 0.8 parts of pigment; 0.1 to 0.2 parts of antifoaming agent; 0.4 to 0.5 parts of dispersant; and 0.1 parts of plasticizer.

The adhesive may be selected from the group consisting of polyvinyl alcohol, polyvinyl acetate emulsion, polyvinylpyrrolidone, acrylic emulsion, or combinations thereof. The suspending agent may be selected from the group consisting of xanthan gum, carbomer resin, sodium carboxymethyl cellulose, and combinations thereof. The humectant may be selected from the group consisting of polyethylene glycol, propylene glycol, glycerol, sorbitol, and combinations thereof. The luminous powder may be either a short-acting powder or a long-acting powder either of which has been subjected to a waterproof coating treatment and the plasticizer may be benzoic acid 990 or benzoic acid 988 of medium to high solubility.

An exemplary method for preparing the first embodiment of the multi-functional aqueous liquid glue of this invention includes: (i)(a) placing deionized water into a reaction tank; (i)(b) adding a suspending agent into the reaction tank in which the temperature is kept at 10° C. to 30° C.; and (iii)(c) performing continuous cutting and dispersion at a speed of 600 r/min to 1000 r/min to obtain a gel-like system with a high-suspension capacity; (ii)(a) adding adhesive to the gel-like system with a high-suspension capacity at a temperature of 10° C. to 30° C.; (ii)(b) stirring the mixture until the adhesive is evenly dispersed; and (ii)(c) raising the temperature to 80° C. to 90° C. with a stirring speed of 70 r/min to 80 r/min to produce a homogeneous and stable colloidal suspension, wherein the adhesive is transformed from a linear polymer structure to a three-dimensional net structure under the effect of the previously added suspending agent and such that colloidal suspension includes a large surface area, high adsorption capacity, and strong suspension capacity; (iii)(a) lowering the temperature and maintaining the temperature at 30° C. to 50° C. after the colloidal suspension has been produced; (iii)(b) adding luminous powder, glitter powder, humectant, bactericide, antifoaming agent, dispersant, and plasticizer in predetermined proportions to the colloidal suspension; and (iii)(c) stirring at a speed of 50 r/min to 60 r/min to obtain a homogeneous liquid suspension; and (iv)(a) adding a water-soluble pigment according to predetermined color specifications; (iv)(b) stirring the suspension liquid thoroughly; (iv)(c) lowering the temperature to 20° C. to 30° C.; and (iv)(d) performing packaging of the glue.

In accordance with a second exemplary embodiment of the present invention, a multi-functional aqueous liquid glue includes the following components according to their parts by weight: 80 parts of deionized water; 18 parts of adhesive; 3 parts of humectant; 4 parts of glitter powder; 5 parts of luminous powder; 1 part of suspending agent; 0.2 parts of bactericide; pigment of 0.6 parts of pigment; 0.1 parts of antifoaming agent; 0.4 parts of dispersant; and 0.1 parts of plasticizer.

The adhesive may be selected from the group consisting of polyvinyl alcohol, polyvinyl acetate emulsion, polyvinylpyrrolidone, acrylic emulsion, or combinations thereof. The suspending agent may be selected from the group consisting of xanthan gum, carbomer resin, sodium carboxymethyl cellulose, and combinations thereof. The humectant may be selected from the group consisting of polyethylene glycol, propylene glycol, glycerol, sorbitol, and combinations thereof. The luminous powder may be either a short-acting powder or a long-acting powder either of which has been subjected to a waterproof coating treatment and the plasticizer may be benzoic acid 990 or benzoic acid 988 of medium to high solubility.

An exemplary method for preparing the second embodiment of the multi-functional aqueous liquid glue of this invention includes: (i)(a) placing deionized water into a reaction tank; (i)(b) adding a suspending agent to the reaction tank in which the temperature is kept at 10° C. to 30° C.; and (i)(c) performing continuous high-speed cutting and dispersion at a speed of 600 r/min to 1000 r/min to obtain a gel-like system with a high-suspension capacity; (ii)(a) adding adhesive to the system with a high-suspension capacity at a temperature of 10° C. to 30° C.; (ii)(b) stirring the mixture until the adhesive is evenly dispersed; (ii)(c) raising the temperature to 80° C. to 90° C.; (ii)(d) stirring the mixture at a speed of 70 r/min to 80 r/min to produce a homogeneous and stable colloidal suspension; and (ii)(e) under the effect of the suspending agent added in step (i)(b), transforming the adhesive from a linear polymer structure to a three-dimensional net structure, such that the system has a large surface area, high adsorption capacity, and strong suspension capacity; (iii)(a) lowering and maintaining the temperature at 30° C. to 50° C. after the foregoing system is produced; (iii)(b) adding luminous powder, glitter powder, humectant, and bactericide in predetermined proportions to the system; (iii)(c) stirring the colloidal suspension at a speed of 50 r/min to 60 r/min until the additives are evenly dispersed; and (iv)(a) adding a water-soluble pigment according to predetermined color specifications; (iv)(b) stirring the colloidal suspension thoroughly; (iv)(c) lowering the temperature to 20° C. to 30° C.; and (iv)(d) packaging the glue product.

In accordance with a third exemplary embodiment of the present invention, a multi-functional aqueous liquid glue includes the following components according to their parts by weight: 75 parts of deionized water; 20 parts of adhesive; 5 parts of humectant; 7 parts of glitter powder; 7 parts of luminous powder; 1.2 parts of suspending agent; 0.3 parts of bactericide; 0.8 parts of pigment; 0.2 parts of antifoaming agent; 0.5 parts of dispersant; and 0.1 parts of plasticizer.

The adhesive may be selected from the group consisting of polyvinyl alcohol, polyvinyl acetate emulsion, polyvinylpyrrolidone, acrylic emulsion, or combinations thereof. The suspending agent may be selected from the group consisting of xanthan gum, carbomer resin, sodium carboxymethyl cellulose, and combinations thereof. The humectant may be selected from the group consisting of polyethylene glycol, propylene glycol, glycerol, sorbitol, and combinations thereof. The luminous powder may be either a short-acting powder or a long-acting powder either of which has been subjected to a waterproof coating treatment and the plasticizer may be benzoic acid 990 or benzoic acid 988 of medium to high solubility.

An exemplary method for preparing the third embodiment of the multi-functional aqueous liquid glue of this invention includes: (i)(a) placing deionized water into a reaction tank; (i)(b) adding a suspending agent to the reaction tank in which the temperature is kept at 10° C. to 30° C.; and (i)(c) performing continuous high-speed cutting and dispersion at a speed of 600 r/min to 1000 r/min to obtain a gel-like system with a high-suspension capacity; (ii)(a) adding adhesive to the gel-like system with a high-suspension capacity at a temperature of 10° C. to 30° C.; (ii)(b) stirring the mixture until the adhesive is evenly dispersed; (ii)(c) raising the temperature to 80° C. to 90° C.; (ii)(d) stirring the mixture at a speed of 70 r/min to 80 r/min to produce a homogeneous and stable colloidal suspension; (ii)(e) under the effect of the suspending agent added in step (i)(b) transforming the adhesive from a linear polymer structure to a three-dimensional net structure, such that the system has a large surface area, high adsorption capacity, and strong suspension capacity; and (iii)(a) lowering and maintaining the temperature at 30° C. to 50° C. after the foregoing system is produced; (iii)(b) adding luminous powder, glitter powder, humectant, and bactericide in predetermined proportions to the system; (iii)(c) stirring the colloidal suspension mixture at a speed of 50 r/min to 60 r/min until the additives are evenly dispersed; and (iv)(a) adding a water-soluble pigment according to predetermined color specifications; (iv)(b) stirring the colloidal suspension mixture thoroughly; (iv)(c) lowering the temperature to 20° C. to 30° C.; and (iv)(d) packing the glue product.

While the present invention has been illustrated by the description of exemplary embodiments thereof, and while the embodiments have been described in certain detail, there is no intention to restrict or in any way limit the scope of the appended claims to such detail. Additional advantages and modifications will readily appear to those skilled in the art. Therefore, the invention in its broader aspects is not limited to any of the specific details, representative devices and methods, and/or illustrative examples shown and described. Accordingly, departures may be made from such details without departing from the spirit or scope of the general inventive concept.

What is claimed:

1. A multi-functional aqueous liquid glue, comprising:
(a) deionized water, wherein the deionized water is present in 70 to 85 parts by weight;
(b) adhesive, wherein the adhesive is present in 15 to 20 parts by weight;
(c) humectant, wherein the humectant is present in 2 to 5 parts by weight;
(d) glitter powder, wherein the glitter powder is present in 4 to 8 parts by weight;
(e) luminous powder, wherein the luminous powder is present in 4 to 8 parts by weight;
(f) suspending agent, wherein the suspending agent is present in 0.6 to 1.2 parts by weight;
(g) bactericide, wherein the bactericide is present in 0.2 to 0.3 parts by weight;
(h) pigment, wherein the pigment is present in 0.4 to 0.8 parts by weight;
(i) antifoaming agent, wherein the antifoaming agent is present in 0.1 to 0.2 parts by weight;
(j) dispersant, wherein the dispersant is present in 0.4 to 0.5 parts by weight; and
(k) plasticizer, wherein the plasticizer is present in 0.1 parts by weight.

2. The glue of claim 1, wherein the adhesive is polyvinyl alcohol, polyvinyl acetate emulsion, polyvinylpyrrolidone, acrylic emulsion, or combinations thereof.

3. The glue of claim 1, wherein the humectant is polyethylene glycol, propylene glycol, glycerol, sorbitol, or combinations thereof.

4. The glue of claim 1, wherein the luminous powder is a short-acting powder that has been subjected to a waterproof coating treatment or a long-acting powder that has been subjected to a waterproof coating treatment.

5. The glue of claim 1, wherein the suspending agent is xanthan gum, carbomer resin, sodium carboxymethyl cellulose, or combinations thereof.

6. The glue of claim 1, wherein the plasticizer is benzoic acid 990 of medium to high solubility or benzoic acid 988 of medium to high solubility.

7. A multi-functional aqueous liquid glue, comprising:
(a) deionized water, wherein the deionized water is present in 70 to 85 parts by weight;
(b) adhesive, wherein the adhesive is present in 15 to 20 parts by weight; and wherein the adhesive is polyvinyl alcohol, polyvinyl acetate emulsion, polyvinylpyrrolidone, acrylic emulsion, or combinations thereof;
(c) humectant, wherein the humectant is present in 2 to 5 parts by weight; and wherein the humectant is polyethylene glycol, propylene glycol, glycerol, sorbitol, or combinations thereof;
(d) glitter powder, wherein the glitter powder is present in 4 to 8 parts by weight;
(e) luminous powder, wherein the luminous powder is present in 4 to 8 parts by weight; and wherein the luminous powder is a short-acting powder that has been subjected to a waterproof coating treatment or a long-acting powder that has been subjected to a waterproof coating treatment;
(f) suspending agent, wherein the suspending agent is present in 0.6 to 1.2 parts by weight; and wherein the suspending agent is xanthan gum, carbomer resin, sodium carboxymethyl cellulose, or combinations thereof;
(g) bactericide, wherein the bactericide is present in 0.2 to 0.3 parts by weight;
(h) pigment, wherein the pigment is present in 0.4 to 0.8 parts by weight;
(i) antifoaming agent, wherein the antifoaming agent is present in 0.1 to 0.2 parts by weight;
(j) dispersant, wherein the dispersant is present in 0.4 to 0.5 parts by weight; and
(k) plasticizer, wherein the plasticizer is present in 0.1 parts by weight; and wherein the plasticizer is benzoic acid 990 of medium to high solubility or benzoic acid 988 of medium to high solubility.

8. A method for making a multi-functional aqueous liquid glue, comprising:
(a) placing deionized water into a reaction tank;
(b) adding a suspending agent into the reaction tank in which the temperature is kept at 10° C. to 30° C.;
(c) performing continuous cutting and dispersion at a speed of 600 r/min to 1000 r/min to obtain a gel-like system with a high-suspension capacity;
(d) adding adhesive to the gel-like system with a high-suspension capacity at a temperature of 10° C. to 30° C.;
(e) stirring the mixture until the adhesive is evenly dispersed;
(f) raising the temperature to 80° C. to 90° C. with a stirring speed of 70 r/min to 80 r/min to produce a homogeneous and stable colloidal suspension, wherein the adhesive is transformed from a linear polymer structure to a three-dimensional net structure under the effect of the previously added suspending agent and such that colloidal suspension includes a large surface area, high adsorption capacity, and strong suspension capacity;
(g) lowering the temperature and maintaining the temperature at 30° C. to 50° C. after the colloidal suspension has been produced;
(h) adding luminous powder, glitter powder, humectant, bactericide, antifoaming agent, dispersant, and plasticizer in predetermined proportions to the colloidal suspension;
(i) stirring at a speed of 50 r/min to 60 r/min to obtain a homogeneous liquid suspension;
(j) adding a water-soluble pigment according to predetermined color specifications;
(k) stirring the suspension liquid thoroughly;
(l) lowering the temperature to 20° C. to 30° C.; and
(m) performing packaging of the glue.

9. The method of claim 8, wherein the suspending agent is xanthan gum, carbomer resin, sodium carboxymethyl cellulose, or combinations thereof.

10. The method of claim 8, wherein the adhesive is polyvinyl alcohol, polyvinyl acetate emulsion, polyvinylpyrrolidone, acrylic emulsion, or combinations thereof.

11. The method of claim 8, wherein the luminous powder is a short-acting powder that has been subjected to a waterproof coating treatment or a long-acting powder that has been subjected to a waterproof coating treatment.

12. The method of claim 8, wherein the humectant is polyethylene glycol, propylene glycol, glycerol, sorbitol, or combinations thereof.

13. The method of claim 8, wherein the plasticizer is benzoic acid 990 of medium to high solubility or benzoic acid 988 of medium to high solubility.

14. The method of claim 8, wherein the deionized water is present in 70 to 85 parts by weight.

15. The method of claim 8, wherein the suspending agent is present in 0.6 to 1.2 parts by weight.

16. The method of claim 8, wherein the adhesive is present in 15 to 20 parts by weight.

17. The method of claim 8, wherein the humectant is present in 2 to 5 parts by weight.

18. The method of claim 8, wherein the luminous powder is present in 4 to 8 parts by weight; wherein the wherein the glitter powder is present in 4 to 8 parts by weight; wherein the bactericide is present in 0.2 to 0.3 parts by weight; wherein the antifoaming agent is present in 0.1 to 0.2 parts by weight; and wherein the dispersant is present in 0.4 to 0.5 parts by weight.

19. The method of claim 8, wherein the plasticizer is present in 0.1 parts by weight.

20. The method of claim 8, wherein the pigment is present in 0.4 to 0.8 parts by weight.
